(19) United States
(12) Patent Application Publication
(10) Pub. No.: US 2017/0034693 A1
(43) Pub. Date: Feb. 2, 2017

(54) BASE STATION APPARATUS

(71) Applicant: FUJITSU LIMITED, Kawasaki-shi (JP)

(72) Inventors: Yoshiyuki ONO, Komae (JP); Kazuya KOBAYASHI, Kawasaki (JP)

(21) Appl. No.: 15/287,399

(22) Filed: Oct. 6, 2016

Related U.S. Application Data
(63) Continuation of application No. PCT/JP2014/060649, filed on Apr. 14, 2014.

(51) Int. Cl. H04W 8/26; H04W 60/00

(52) U.S. Cl. CPC H04W 8/26; H04W 60/005; H04W 88/08

(57) ABSTRACT

A base station apparatus includes a memory; and a processor coupled to the memory, the processor configured to: sequentially acquire terminal identification IDs, and update and retain the terminal identification IDs. Each of the terminal identification IDs indicates a current connection state of a terminal with respect to each second base station apparatus among second base station apparatuses of cells managed by the base station apparatus including a cell of the base station apparatus. The processor, when communication is performed with the terminal through carrier aggregation, acquires the terminal identification IDs in the cells subject to the carrier aggregation and obtains a usable terminal identification ID usable across the cells subject to the carrier aggregation.

### CROSS REFERENCE TO RELATED APPLICATIONS

This application is a continuation application of International Application PCT/JP2014/060649, filed on Apr. 14, 2014, and designating the U.S., the entire contents of which are incorporated herein by reference.

### FIELD

The embodiments discussed herein relate to a base station apparatus that performs communication by carrier aggregation.

### BACKGROUND

Third Generation Partnership Project (3GPP) is studying LTE-Advanced (LTE-A) as the next communication mode of Long Term Evolution (LTE). LTE-A is aimed to achieve higher-speed communication than LTE and is desired to support a broader band than LTE (e.g., a band up to 100 MHz exceeding the 20 MHz band of LTE).

Therefore, 3GPP has proposed a technique called carrier aggregation (CA) achieving high-speed, large capacity communication. In CA, multiple carriers having a bandwidth up to 20 MHz are collectively used for communication to maintain compatibility (backward compatibility) with LTE as far as possible. For example, by using five sectors each having 20 MHz, a bandwidth may be ensured up to 100 MHz. In CA, a carrier up to 20 MHz is referred to as a component carrier (CC).

A base station (eNB) of an LTE system manages terminal identification IDs called Cell Radio Network Temporary Identifiers (C-RNTIs) for identifying a terminal (UE). When a connection is established between a UE and an eNB, a C-RNTI is assigned from the eNB to the UE by using a Random-Access Channel (RACH) Procedure, and the C-RNTI is used during call connection to enable independent communication for each UE.

The C-RNTI is prescribed to be the terminal identification ID from 1 to 65523 per cell in Chapter 7.1 RNTI values of 3GPP, “3GPP, TS 36.321 v10.5.0 (2012-03)”, 3rd Generation Partnership Project; Technical Specification Group Radio Access Network; Evolved Universal Terrestrial Radio Access (E-UTRA); Medium Access Control (MAC) protocol specification (Release 10), pp. 45-46. Since a UE may be present in only one cell in the LTE system, the definition is on the basis of cell. If cells are different, a C-RNTI is allowed to be duplicated.

In “3GPP TS 36.300 V10.3.0 (2011-03)”, 3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 10), p. 46, pp. 56-57, p. 62, pp. 70-71, p. 73, specifications are included in CA (Chapters 5.5 and 7.5), C-RNTI (Chapter 8.1), Handover (Chapter 10.1.2.1), RACH Procedure (Chapter 10.1.5), and Non-Contention Based Random Access Procedure (FIG. 10.1.5.2-1). Additionally in “3GPP TS 36.300 V10.3.0 (2011-03)”, 3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 10), p. 46, pp. 56-57, p. 62, pp. 70-71, p. 73, CA supporting an RRH of an uplink (UL) is discussed as Deployment Scenario 4 (the case indicated by #4 described in Annex J (informative): Carrier Aggregation J.1 Deployment Scenarios).

Conventional techniques associated with, for example, performing a cell search for a cell of CA include techniques of searching for a secondary cell based on reception quality of a carrier detection signal (see, e.g., Japanese Laid-Open Patent Publication Nos. 2013-157823 and 2013-222976). In another technique of searching for a secondary cell, a cell identifier of a primary cell is used in a multicomponent carrier cell (see, e.g., Japanese Laid-Open Patent Publication No. 2011-525327).

### SUMMARY

According to an aspect of an embodiment, a base station apparatus includes a memory; and a processor coupled to the memory, the processor configured to: sequentially acquire terminal identification IDs, and update and retain he terminal identification IDs. Each of the terminal identification IDs indicates a current connection state of a terminal with respect to each second base station apparatus among second base station apparatuses of cells managed by the base station apparatus including a cell of the base station apparatus. The processor, when communication is performed with the terminal through carrier aggregation, acquires the terminal identification IDs in the cells subject to the carrier aggregation and obtains a usable terminal identification ID usable across the cells subject to the carrier aggregation.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a system configuration diagram of a communication apparatus including a base station apparatus according to an embodiment;

FIG. 2 is a block diagram of an internal configuration example of a base station apparatus according to the embodiment;

FIG. 3 is a sequence diagram of the timing of CA start and addition according to the embodiment;

FIG. 4 is a sequence diagram of an internal process of the base station (eNB) according to the embodiment;

FIG. 5 is a sequence diagram of details of an RNTI search process according to the embodiment;

FIG. 6 is a diagram explaining a calculation for available RNTI; and

FIG. 7 is a flowchart of a process example of the available RNTI calculation.

### DESCRIPTION OF THE INVENTION

Embodiments of the disclosure will be described in detail with reference to the accompanying drawings.

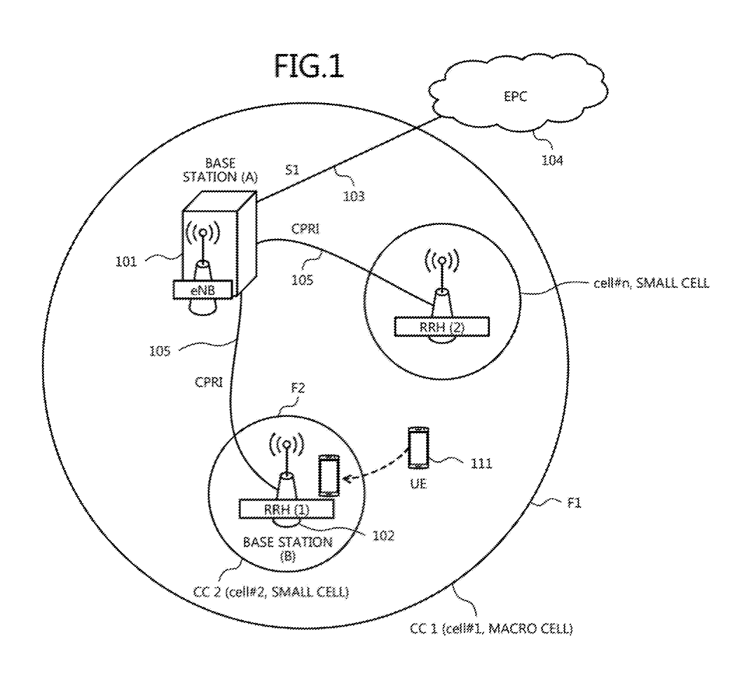

FIG. 1 is a system configuration diagram of a communication apparatus including a base station apparatus according to an embodiment. As depicted in FIG. 1, a first communication area CC1 (cell#1) is referred to as, for example, a macro cell (or macro coverage, a primary cell, CC1 (cell#1)) and a second communication area is referred to as, for example, a small cell (or small coverage, a secondary cell, CC2 (cell#2)). CC stands for a component carrier. The relation between the first communication area and the second communication area may be reversed.

As described in “3GPP TS 36.300 V10.3.0 (2011-03)”, 3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 10), p. 46, pp. 56-57, p. 62, pp. 70-71, p. 73, CA supporting an RRH 102 of an uplink (UL) is under study. Accordingly, as depicted in FIG. 1, overlay arrangement of one or more small cells cell#2 to cell#n may be implemented under a macro cell cell#1 in some cases. In this arrangement, if a terminal (UE) 111 moves from the macro cell cell#1 to the small cell cell#2, the terminal (UE) 111 becomes able to access both a base station A (101) of the macro cell cell#1 and a base station B (1092) of the small cell cell#2. As a result, the terminal (UE) 111 can perform CA through communications with the macro cell cell#1 and the multiple small cells cell#2 to #n.

The cells may be referred to by any name as long as the small cell (secondary cell) cell#2 is in the relation of the overlay arrangement under the macro cell (primary cell) cell#1 as depicted in FIG. 1. Examples of names of the cells include a macro cell, a femtocell, a picocell, a microcell, etc. Femtocells, picocells, and microcells may collectively be referred to as small cells.

The macro cell cell#1 and the small cell cell#2 may use different frequencies F1, F2. For example, the frequency F2 used in the small cell cell#2 is higher than the frequency F1 used in the macro cell cell#1.

A second base station apparatus (base station B) 102 forming the small cell cell#2 is also referred to as a remote radio head (RRH). On the other hand, a first base station apparatus (base station A) 101 forming the macro cell cell#1 is also referred to as a base transceiver station (BTS) or Evolved Node B (eNB).

For example, the RRH 102 is disposed where traffic is intensively occurs (referred to as a hot spot) or a dead zone of the macro cell cell#1. As a result, the traffic of the hot spot may be absorbed by the RRH 102 or the dead zone of the macro cell cell#1 may be compensated by the RRH 102.

The base station A (101) and the RRH (102) may be considered as individual base station apparatuses or may be considered as forming one base station apparatus.

The base station A (101) is connected through a transmission path 103 such as an S1 interface, etc. to an Evolved Packet Core (EPC) 104 of a core network. The EPC 104 is made up of, but not limited to, Packet Data Network (PDN) Gateway (P-GW), Serving Gateway (S-GW), and Mobility Management Entity (MME), for example.

The base station A (101) is connected according to, for example, a Common Public Radio Interface (CPRI) format, which is a standard communication format, through transmission paths (such as optical fiber cables) 105 to multiple RRHs (1) and (2). The connection of the base station A (101) to the RRH (1) and the RRH (2) may be achieved through the base station B (102) connected through an X2 interface prescribed by the 3GPP standard. The connection between a base station and an RRH is not limited to CPRI.

With reference to FIG. 1, CA will be described with respect to a case where the terminal (UE) 111 moves from the macro cell cell#1 to an area where the macro cell cell#1 and the small cell cell#2 overlap (in the depicted example, an area of the small cell cell#2). In this case, while the terminal (UE) 111 is communicating with the macro cell cell#1 (primary cell), the small cell cell#2 (secondary cell) is added through CA.

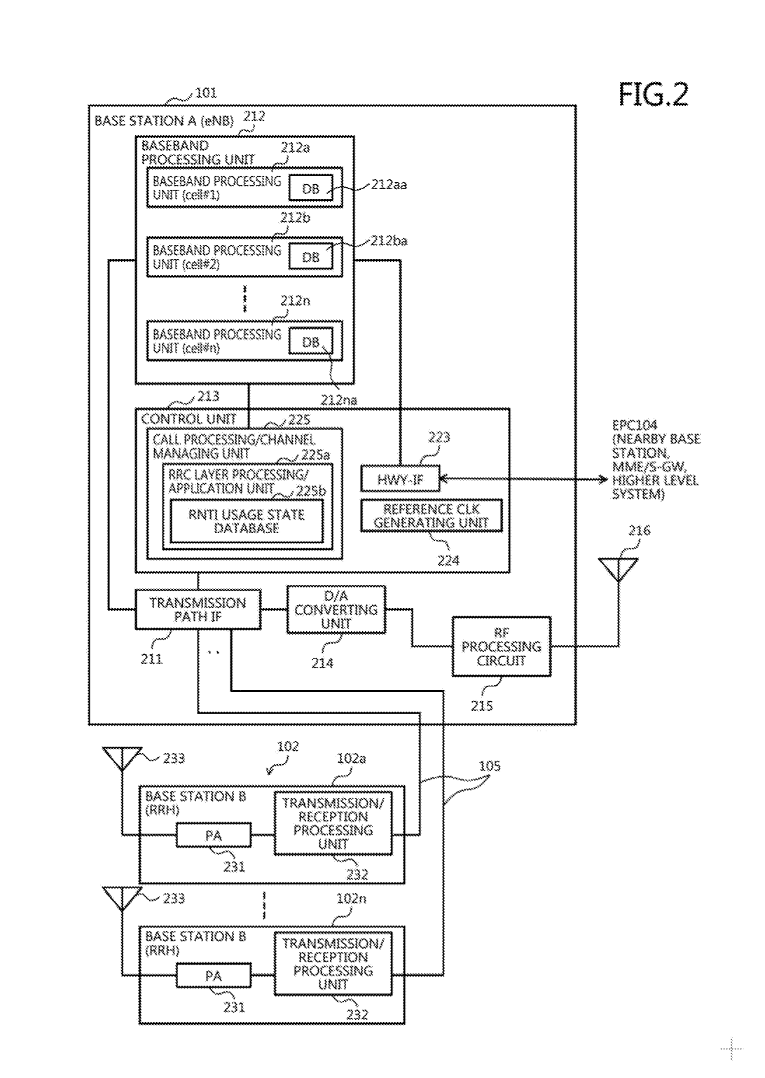

FIG. 2 is a block diagram of an internal configuration example of a base station apparatus according to the embodiment. FIG. 2 depicts the first base station apparatus (base station A, eNB) 101 and wireless units (RRHs) connected to multiple second base station apparatuses or the RRHs (base stations B, RRHs) 102 directly connected through CPRI to the base station A.

The base station A (eNB) 101 includes a transmission path interface (IF) 211, a baseband processing unit 212, a control unit 213, a D/A converting unit 214, an RF processing circuit 215, and an antenna 216.

The transmission path IF 211 transfers signals according to the CPRI format through the transmission paths (such as optical fiber cables) 105 to and from the second base station apparatuses (RRHs) 102.

The baseband processing unit 212 executes signal processing for a downlink (DL) transmission signal received through the transmission path IF 211 and an uplink (UL) reception signal received from the UE 111. This baseband processing unit 212 has multiple baseband processing units 212a to 212n.

The baseband processing unit 212a executes DL and UL signal processing for the macro cell cell#1 (primary cell) of the eNB 101, for example. The baseband processing units 212b to 212n are disposed corresponding to the respective RRHs 102 to execute DL and UL signal processing for the secondary cells (cell#2 to cell#n), for example. Therefore, the baseband processing units 212b to 212n are respectively connected via the transmission path IF 211 through CPRI to the multiple RPHs 102 (102b to 102n).

The baseband processing units 212a to 212n store and retain respective RNTI usage states in databases 212aa to 212na.

The D/A converting unit 214 converts the DL digital signal processed by the baseband processing unit 212 into an analog signal and transmits the signal to the RF processing circuit 215. The D/A converting unit 214 converts the UL analog signal received from the RF processing circuit 215 into a digital signal and outputs the signal to the baseband processing unit 212.

The RF processing circuit 215 up-converts a DL signal input from the D/A converting unit 214 to a radio frequency and outputs the signal to the antenna 216. The RF processing circuit 215 down-converts a UL signal received via the antenna 216 and outputs the signal to the D/A converting unit 214.

The antenna 216 emits a DL wireless signal input from the RF processing circuit 215 to a space (the UE 111) and outputs a UL wireless signal received from the space (the UE 111) to the RF processing circuit 215.

The control unit 213 includes a wired transmission path interface functional unit (HWY-IF) 223, a reference clock (CLK) generating unit 224, and a call processing/channel managing unit 225. The HWY-IF 223 is a connection interface for the EPC 104 (e.g., a core network (MME/S-GW), a control apparatus controlling the eNB 101, or another base station apparatus) and executes a process of protocol conversion, etc. corresponding to the transmission path 103 (e.g., the S1 interface). An interface connecting other eNBs to each other is generally considered to be a wired connection called the X2 interface or may be a wireless connection.

The reference CLK generating unit 224 has a frequency oscillator and generates a reference clock used by the eNB 101. The call processing/channel managing unit 225 carriers out wireless link management, call control, BTS state management, and state control.

The cell processing/channel managing unit 225 includes an RRC layer processing/application unit 225a and processes exchange of network layer information, etc. The RRC layer processing/application unit 225a accesses the databases 212aa to 212na of the baseband processing unit 212a to 212n continuously (or at a predetermined timing) to acquire the RNTI usage states of the respective cells (cell#1 to cell#n).

The RRC layer processing/application unit 225a has an RNTI usage state database 225b. RNTIs for which usage states in the cells (cell#1 to cell#n) subject to CA are acquired from the respective databases 212aa to 212na at the time of execution of CA are integrated and the RNTI usage state database 225b retains in an updatable state, the RNTIs that may be used for CA.

For example, the RRC layer processing/application unit 225a acquires the RNTI usage states of other base stations that are subject to CA, i.e., that may execute CA through concurrent communication with the cell (cell#1) of the base station A (101) of the macro cell. For example, in the example depicted in FIG. 1, the RRC layer processing/application unit 225a acquires the RNTI usage states of the RRHs 1, 2, i.e., the base station B (102), through the transmission paths 105 such as the X2 interface and stores and retains the RNTI usage states in the RNTI usage state database 225b. A detailed configuration of calculation of an RNTI at the time of execution of CA will be described later.

The base station B (RRHs) 102 (102a to 102n) each have a power amplifier (PA: Power Amp) 231, a transmission/reception processing unit 232, an antenna 233, etc. The transmission/reception processing unit 232 has a function of converting transmission data generated at the RRH 102 into a wireless signal. The transmission/reception processing unit 232 includes a DA converter, an inverter, an up-converter expanding signals on a frequency axis, etc., not depicted.

The transmission/reception processing unit 232 has a low noise amplifier (LNA) and amplifies a reception signal from the antenna 233. The transmission/reception processing unit 232 also has a signal down-converter and a function of processing a signal as digital reception data through sampling by an AD converter. The transmission/reception processing unit 232 includes an interface unit, etc. that converts into a CPRI format, a signal through the transmission path 105 with the eNB 101 and performs transmission and reception with respect to the eNB 101.

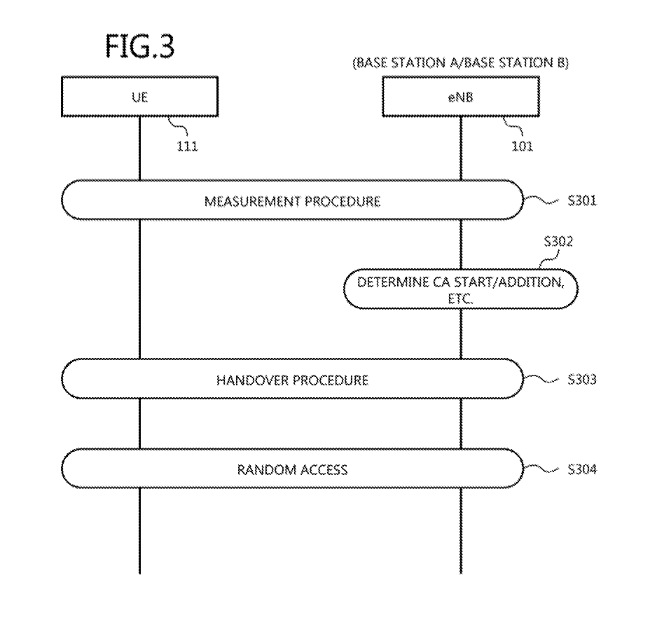

FIG. 3 is a sequence diagram of the timing of CA start and addition according to the embodiment. Process procedures are mainly described with respect to CA subsequent to establishment of a communication state between the terminal (UE) 111 and the base station A (eNB) 101. The base station B (RRH) 102 executes a process related to CA in corporation with the base station A (eNB) 101.

In an example of CA in the following description, as depicted in FIG. 1, the multiple base stations A, B are connected for communication to the one UE 111. First, the eNB 101 receives Measurement Report, etc. transmitted by the UE 111 by a Measurement Procedure (step S301). Measurement Report includes cell information such as radio wave intensities and cell identifiers of the base stations A, B detected by the UE 111, and is reported to the base station A.

Subsequently, the eNB 101 determines CA start/addition, etc. (step S302). In this case, the eNB 101 determines to execute CA by using the multiple base stations A, B having a predetermined radio wave intensity (good communication quality) reported from the UE 111. For example, in the example depicted in FIG. 1, if the UE 111 is located in the small cell cell#2 of the RRH 102 and is in a good communication state with the base station B (RRH) 102, the small cell cell#2 of the RRH 102 is determined as a secondary cell (additional cell).

In the present embodiment, the eNB 101 changes a communication parameter of the UE 111 for the CA addition by a Handover Procedure (step S303).

Therefore, in the present embodiment, the eNB 101 searches for a C-RNTI usable in all the cells subject to CA in the Handover Procedure (described in detail later). In this case, the eNB 101 searches for an available RNTI for assigning to the UE 111, one C-RNTI common to the base stations executing CA (in the example depicted in FIG. 1, the eNB 101 and the RRH 102). The eNB 101 then notifies the UE 111 of information of the RRH 102 allowed to be added to CA and information of another RRH 102 to be added (including notification of the one common C-RNTI), by the Handover Procedure.

Subsequently, when the UE 111 accepts the information of CA (the RRH 102 to be added etc.), the eNB 101 executes a RACH Procedure through Random Access (step S304). In this procedure of Random Access, the eNB 101 and the RRH 102 execute a process of connecting to the UE 111 with the communication parameter changed through the Handover Procedure at step S303.

In a subsequent procedure, the eNB 101 and the RRH 102 perform data communication through CA with the UE 111.

As described above, in the present embodiment, with regard to the determination of the C-RNTI at the time of addition of a secondary cell in the case of the wireless communication through CA, the one eNB 101 taking the lead in CA control determines the CA start/addition based on a Measurement Report, etc. from the UE 111. After determining the CA start/addition, the eNB 101 executes notification of the C-RNTI and a connection process to the (secondary cell) base station (RRH) 102 subject to CA by a Handover Procedure.

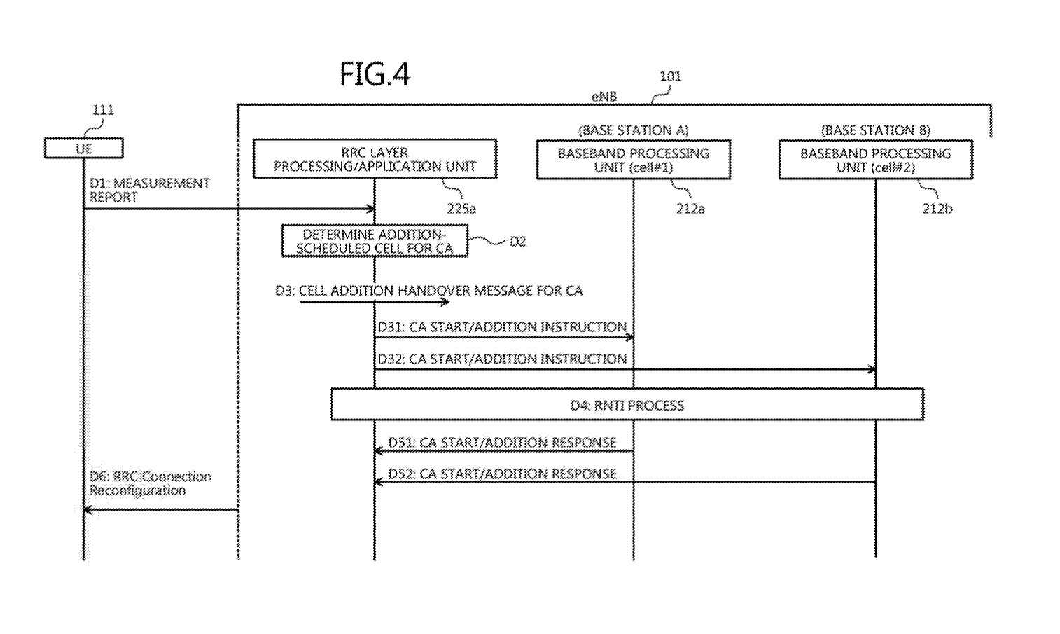

FIG. 4 is a sequence diagram of an internal process of the base station (eNB) according to the embodiment. In the state described as an example, as depicted in FIG. 1, the UE 111 is located in the cell (cell#2) of the RRH 102.

First, the RRC layer processing/application unit 225a receives the Measurement Report transmitted from the UE 111 (D1), and the eNB 101 determines an addition-scheduled cell for CA (D2). In this case, the RRC layer processing/application unit 225a determines the number of cells (the number of secondary cells to be added) and the band of CA for the UE 111 according to the capability (band) of the UE 111. In this example, for example, it is assumed that the small cell cell#2 of the base station B (RRH) 102 is determined as the secondary cell (additional cell).

The RRC layer processing/application unit 225a outputs a cell addition handover message for CA (D3). The RRC layer processing/application unit 225a gives a CA start/addition instruction to the baseband processing unit 212a of the base station A (the eNB 101, cell#1) (D31). The RRC layer processing/application unit 225a gives a CA start/addition instruction to the baseband processing unit 212b of the base station B (the RRH 102, cell#2) (D32).

Subsequently, the RRC layer processing/application unit 225a and the baseband processing units 212a, 212b execute an RNTI process to execute a process of searching for one available RNTI common to cell#1 and cell#2 for CA (D4).

Thereafter, the baseband processing unit 212a of the base station A (the eNB 101, cell#1) gives the RRC layer processing/application unit 225a a CA start/addition response (D51), and the baseband processing unit 212b of the base station B (the RRH 102, cell#2) gives the RRC layer processing/application unit 225a a CA start/addition response (D52).

Subsequently, the RRC layer processing/application unit 225a notifies the UE 111 of information such as an RNTI related to the CA addition through RRC Connection Reconfiguration (D6).

Addition, deletion, and reconfiguration of the secondary cell are performed by providing a control signal from the primary cell to the UE 111, for example. For example, when determining addition of a secondary cell, the eNB 101 transmits Radio Resource Control (RRC) signaling through a control plane to the UE 111. An example of the RRC signaling is a message of RRC Connection Reconfiguration (D6).

When receiving the message of the RRC signaling (D6), the UE 111 carries out CC control to start a communication preparation process for the secondary cell and transmits to the eNB, a response signal to the received RRC signaling. An example of the response signal is a message of an RRC Connection Reconfiguration Complete message.

When receiving the response signal from the UE 111, the eNB 101 transmits to the UE 111, a control signal giving an instruction for activating the secondary cell. This control signal may be transmitted as a control element (MAC CE) of the MAC layer. The eNB 101 may manage the secondary cell in the MAC layer. For example, the activation and deactivation of the secondary cell and the control of the discontinuous reception (DRX) of the secondary cell may be achieved through the MAC CE.

When receiving the MAC CE giving an instruction for activating the secondary cell, the UE 111 activates the secondary cell. The UE 111 activating the secondary cell may start a timer counting the time of cancelation of the activated secondary cell. In this case, when the timer expires, the UE 111 autonomously cancels the secondary cell. The timer is referred to as a Scell Deactivation timer in some cases.

In the embodiment, the eNB 101 (the RRC layer processing/application unit 225a) performs one handover for the UE 111 through RRC Connection Reconfiguration (D6).

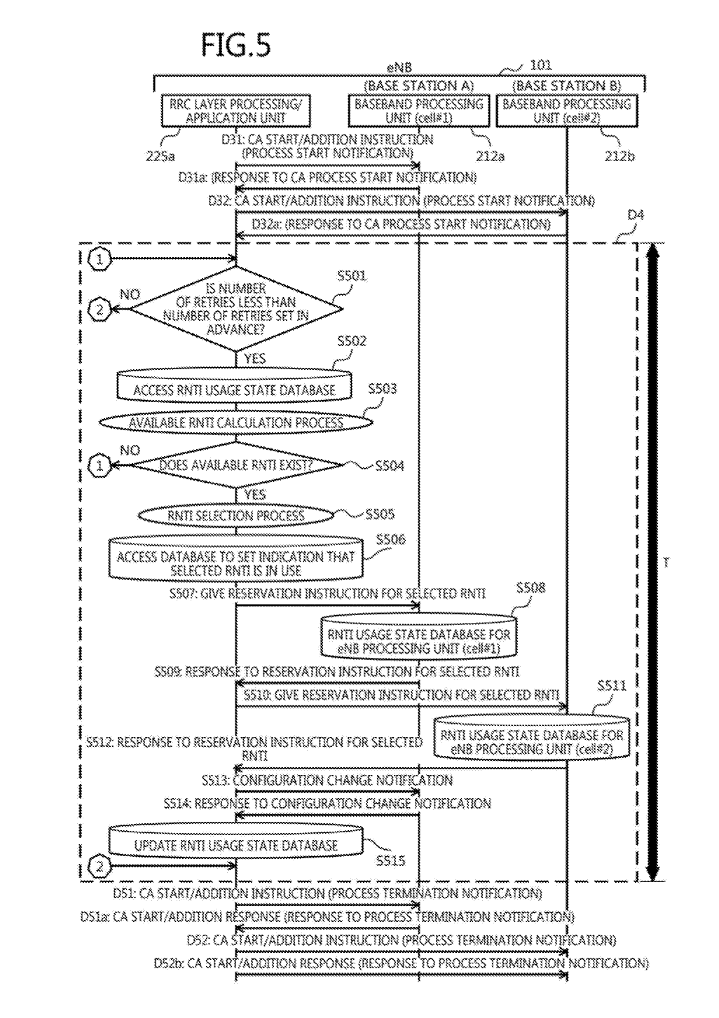

FIG. 5 is a sequence diagram of details of an RNTI search process according to the embodiment. With reference to FIG. 5, details of the RNTI search process (D4) depicted in FIG. 4 will mainly be described.

First, the RRC layer processing/application unit 225a gives a CA start/addition instruction (in this case, a CA process start notification) to the baseband processing unit 212a of the base station A (the eNB 101, cell#1) (D31). The baseband processing unit 212a gives the RRC layer processing/application unit 225a a response to the CA process start notification (D31a). The RRC layer processing/application unit 225a also gives a CA start/addition instruction (in this case, a CA process start notification) to the baseband processing unit 212b of the base station B (the RRH 102, cell#2) (D32). The baseband processing unit 212b gives the RRC layer processing/application unit 225a a response to the CA process start notification (D32a).

Subsequently, the RRC layer processing/application unit 225a and the baseband processing units 212a, 212b execute the RNTI process and execute the process of searching for one available RNTI common to cell#1 and cell#2 for CA (D4).

In this RNTI search process D4, first, the RRC layer processing/application unit 225a determines whether the number of retries is les than the number of retries set in advance in the RNTI configuration (step S501). If the number of retries is les than the number of retries in the RNTI configuration (step S501: YES), the following process is executed, or if the number of retries is equal to greater than the number of retries in the RNTI configuration (step S501: NO), the process is terminated without executing the RNTI search process (the process goes to D51).

The RRC layer processing/application unit 225a accesses the RNTI usage state database 225b (step S502) and executes an available RNTI calculation process based on the current RNTI usage state (step S503).

The RRC layer processing/application unit 225a determines whether one available RNTI exists that is common to cell#1 and cell#2 for CA (step S504). If an available RNTI exists (step S504: YES), the following process is executed, or if no common available RNTI exists (step S504: NO), the RRC layer processing/application unit 225a returns to step S501 to check the number of retries.

If the number of retries is less than the set number of retries (step S501: YES), the RRC layer processing/application unit 225a accesses the RNTI usage state database 225b again. In this case, for example, even if the RNTI information of the same cell is used, since communication situations of other UEs continuously change and the RNTI usage state database 225b is updated, the information acquired by accessing the database again is used for executing the available RNTI calculation process. If no available RNTI is found even after this process is repeated for the number of retries (step S501: NO), this is considered as NG and the RNTI search process D4 is terminated (the process goes to D51).

The RRC layer processing/application unit 225a then executes a process of selecting one RNTI used for this CA among available RNTIs (step S505). The RRC layer processing/application unit 225a accesses the RNTI usage state database 225b to set indication that the selected RNTI is in use (step S506).

Subsequently, the RRC layer processing/application unit 225a gives a reservation instruction for the one RNTI selected at step S505 to the baseband processing unit 212a of the base station A (the eNB 101, cell#1) (step S507).

The baseband processing unit 212a of the base station A (the eNB 101, cell#1) searches the database 212aa to confirm the currently processing RNTIs (step S508) and gives a response of whether a process may be executed with the RNTI of the RNTI reservation instruction (step S509).

If the response result from the baseband processing unit 212a of the base station A (the eNB 101, cell#1) is OK, the RRC layer processing/application unit 225a gives a reservation instruction to use the one RNTI selected at step S505 to the baseband processing unit 212b of the base station B (the RRH 102, cell#2) (step S510).

The baseband processing unit 212b of the base station B (the RRH 102, cell#2) searches database 212ba (step S511) to determine whether a process may be executed with the RNTI of the instruction and gives a response to the RNTI reservation instruction (step S512).

If the response result from the base station B is OK, the RRC layer processing/application unit 225a gives a configuration change notification to the baseband processing unit 212a of the base station A (step S513). The configuration change notification is given so as to give notification of information concerning reconfiguration such as addition, deletion, etc. of the secondary cell related to CA.

The baseband processing unit 212a accesses the database 212aa and sets indication that the selected RNTI has been confirmed to be in use. The baseband processing unit 212a then gives the RRC layer processing/application unit 225a a response to the configuration change notification (step S514).

On the other hand, if the response result from the base station B is NG, the RRC layer processing/application unit 225a sets the RNTI of the instruction as being currently in use in the RNTI usage state database 225b. Additionally, usage reservation is set also in the database of the eNB 101 (cell#1) that gave the instruction or the database 212ba of the RHH 102 (cell#2), and an RNTI release process is executed (although not depicted, in this case, the set number of retries at step S501 is checked and, if a threshold value has not been reached (step S501: YES), the same process as above is repeated until the RNTI can be determined).

The RRC layer processing/application unit 225a updates the RNTI usage state database 225b based on the response to the configuration change notification (step S515). As a result, the RNTI search process D4 is terminated.

Subsequently, the RRC layer processing/application unit 225a gives a CA start/addition instruction (in this case, a CA process termination notification) to the baseband processing unit 212a of the base station A (the eNB 101, cell#1) (D51). The baseband processing unit 212a gives the RRC layer processing/application unit 225a a response to the CA process termination notification (D51a). Additionally, the RRC layer processing/application unit 225a gives a CA start/addition instruction (in this case, a CA process termination notification) to the baseband processing unit 212b of the base station B (the RRH 102, cell#2) (D52). The baseband processing unit 212b gives the RRC layer processing/application unit 225a a response to the CA process termination notification (D52b).

In the process, a time T consumed for the RNTI search process D4, i.e., one retry, is 5 msec, for example. The basis for this is that an RNTI of multiple cells subject to CA may be searched for through internal processing by the base station A (the eNB 101) alone.

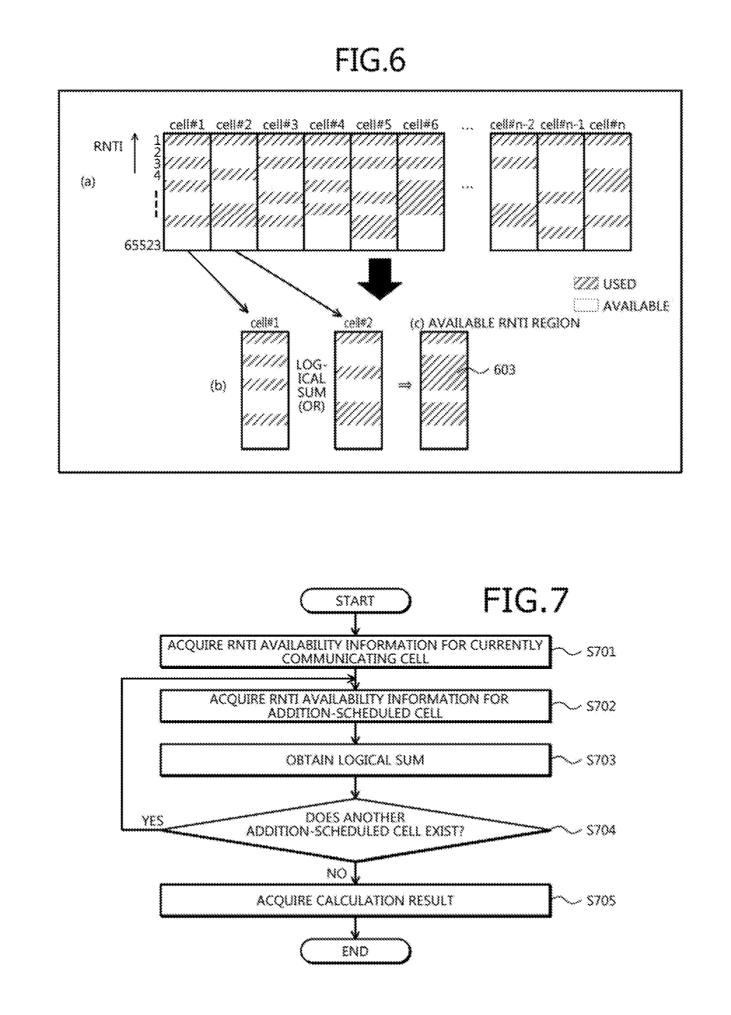

FIG. 6 is a diagram explaining a calculation for available RNTI. Description will be made of an available RNTI calculation process executed by the RRC layer processing/application unit 225a at step S503 depicted in FIG. 5.

The baseband processing units 212a to 212n retain RNTI usage states of the cells (cell#1 to cell#n) on the databases 212aa to 212na. As depicted in FIG. 6 (a), in the embodiment, the cells (cell#1 to cell#n) have a one-bit usage state identifier added as RNTI availability information for each of the RNTI terminal identification IDs, for example, 1 to 65523. For example, an RNTI in use is set to a bit “1”, and an RNTI not in use is set to a bit “0” or managed without setting a bit.

At the processing timing for the available RNTI calculation process, the RRC layer processing/application unit 225a calculates one available RNTI of cells for CA, common to cells used by the UE 111 (step S503).

For example, description will be made of a case where cell#2 is added as the secondary cell during communication of the UE 111 in cell#1 as depicted in FIG. 1. In this case, as depicted in FIG. 6 (b), the RRC layer processing/application unit 225a accesses the databases 212aa, 212ba to acquire all the data of the two cells cell#1, cell#2 in which CA is executed (respective tables each having 65523 bits). From all the data of these two cells cell#1 and cell#2, a logical sum (or) is obtained for each of the same terminal identification IDs.

The RRC layer processing/application unit 225a temporarily retains the result of logical sum as an available RNTI region 603 for CA depicted in FIG. 6 (c) in the RNTI usage state database 225b, and executes an RNTI selection process (step S505 of FIG. 5) based on this region.

FIG. 7 is a flowchart of a process example of the available RNTI calculation. The process executed by the RRC layer processing/application unit 225a will be described. First, the RRC layer processing/application unit 225a accesses the database 212aa of the baseband processing unit 212a to acquire RNTI availability information for currently communication cell#1 (step S701).

The RRC layer processing/application unit 225a accesses the database 212ba of the baseband processing unit 212b of the addition-scheduled cell cell#2 to acquire RNTI availability information of cell#2 (step S702).

Subsequently, the RRC layer processing/application unit 225a obtains a logical sum (or) for each of the same terminal identification IDs from all the data of these two cells cell#1 and cell#2 (step S703).

Subsequently, the RRC layer processing/application unit 225a determines whether another addition-scheduled cell exists (step S704) and, if a cell is to be added (step S704: YES), the RRC layer processing/application unit 225a returns to step S702 and acquires the RNTI availability information of the addition-scheduled cell to obtain the logical sums.

If no additional cell exists (all the cell additions are completed) at step S704 (step S704: NO), one RNTI may be acquired that is usable in common in all the cells scheduled to be used by the UE 111 for CA (step S705).

According to the available RNTI calculation process, the available RNTI of all the cells subject to CA may be easily retrieved through a logical sum operation of the same terminal identification IDs between the cells subject to CA. In this case, since only the 1-bit simple logical sum operation is required, the available RNTI of all cells subject to CA may be calculated at high speed. The RRC layer processing/application unit 225a has a lower processing speed as compared to the baseband processing unit 212.

However, the available RNTI of all the cells subject to CA may be retrieved at high speed by searching the available RNTI region 603 (table) acquired through the logical sum operation only once. As a result, even the RRC layer processing/application unit 225a having a lower processing speed can efficiently retrieve the available RNTI in a short time. Since the available RNTI can be retrieved efficiently in a short time, an actually usable RNTI may be acquired through only one search of a higher possibility though the RNTI usage states constantly changes in each cell, whereby the number of retries may be reduced. The RRC layer processing/application unit 225a may reduce the processing load of searching for an available RNTI.

The processing time consumed for determining the RNTI in the present embodiment described above will be described. According to the present embodiment, after the determination of the CA addition (step S302) depicted in FIG. 3, the RNTI may be configured within the process steps of the procedure of Handover Procedure alone (step S303). Therefore, the eNB 101 may process the RNTI determination internally without a need to communicate with or connect to the UE 111. In this case, the time T consumed for the RNTI search process D4 depicted in FIG. 5 is merely 5 msec. Even if five retries are made, the RNTI for CA may be acquired in the processing time of 25 msec.

In contrast, to search the secondary cell by existing schemes, the procedure of Handover Procedure (step S303) and the procedure of Random Access (step S304) of FIG. 3 are executed to configure the RNTI. In this case, the RNTI for CA cannot be acquired from the cells at one time, and a time of about 120 msec is consumed for the operations at steps S303 and S304 each time the eNB 101 repeats a retry (handover) to the UE 111. If five retries are made, the processing time of 600 msec is required. As described above, according to the embodiment, an available RNTI can be retrieved efficiently at high speed as compared to existing schemes.

Although a transition from standby (idling) to entry into a cell and establishment of a communication state is specified to be made within 100 ms in the LTE standard, the transition from standby to the communication state is more strictly prescribed to be made within 50 ms in LTE-A, and a shorter latency is required. With regard to this requirement, the embodiment may satisfy the required conditions of LTE-A and simplify up to and through a CA establishment procedure in LTE-A so as to significantly reduce the time until CA is established.

In the specifications of 3GPP Release 10 or later, introduction of CA into LTE-A enables one UE to communicate with multiple eNBs at the same time. In LTE-A (Rel. 10), the definition of C-RNTI is not changed from LTE (a numerical value from 1 to 65523 for each cell) so as to achieve compatibility with UEs compatible with LTE (Rel. 8, Rel. 9).

Since a UE of LTE communicates with one cell without crossing a boundary between cells, a C-RNTI is allowed to be duplicated on the basis of cell. In contrast, since a UE performing CA in LTE-A connects to multiple cells at the same time, a C-RNTI must be made common in all the cells with which the UE communicates at the same time. Each UE can retain one C-RNTI. Thus, although the duplication of C-RNTIs is allowed in LTE if cells are different, the duplication is not allowed in cells in which CA is executed under LTE-A.

Since a RACH Procedure for ensuring the C-RNTI is executed in only one cell (primary cell) also under LTE-A, determining assignment of the C-RNTI, which is commonly used across the multiple cells subject to CA, has become a problem to be solved; however, an effective technique has not been disclosed at present.

Currently, whether a C-RNTI obtained first in the primary cell is usable when a cell subject to CA (secondary cell) is added is confirmed. If the cells subject to CA are being used to the number corresponding to a bandwidth necessary for a terminal, the C-RNTI is changed to repeatedly retry connection to the primary cell. Therefore, a process (RACH procedure) of searching for a C-RNTI that may be commonly used in all the cells subject to CA may frequently occur and, in this case, it takes an extremely long time to establish CA.

According to one embodiment, the time until establishment of carrier aggregation may be shortened.

The baseband processing unit 212 and the control unit 213 described above, for example, may be realized by executing on a processor such as a central processing unit (CPU), a program read from memory. Further, the respective databases described above, for example, may be realized by memory.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A base station apparatus comprising:
a memory; and
a processor coupled to the memory, the processor configured to:
sequentially acquire terminal identification IDs, and
update and retain the terminal identification IDs, wherein
each of the terminal identification IDs indicates a current connection state of a terminal with respect to each second base station apparatus among second base station apparatuses of cells managed by the base station apparatus including a cell of the base station apparatus, and
the processor, when communication is performed with the terminal through carrier aggregation, acquires the terminal identification IDs in the cells subject to the carrier aggregation and obtains a usable terminal identification ID usable across the cells subject to the carrier aggregation.

2. The base station apparatus according to claim 1, wherein
the processor updates and retains a table configured to use one bit to indicate for each of the terminal identification IDs, current usage in each of the cells by the terminal, and
the processor acquires the table of the terminal identification IDs from, each of the cells subject to the carrier aggregation and obtains the usable terminal identification ID usable across the cells subject to the carrier aggregation from bit logical sums for each of the terminal identification IDs, between the tables.

3. The base station apparatus according to claim 1, wherein
the processor notifies the terminal of the obtained usable terminal identification ID related to the cells subject to the carrier aggregation.

4. The base station apparatus according to claim 1, wherein
the processor updates and retains in respective databases, a terminal identification ID indicating a current connection state of a terminal to a macro cell of the base station apparatus and a terminal identification ID indicating a current connection state of a terminal to a small cell included in the macro cell.

5. The base station apparatus according to claim 4, wherein
the processor, when communication is performed through carrier aggregation, acquires a table of the terminal identification IDs from each of the databases for the cells subject to the carrier aggregation and stores and retains in an RNTI usage state database, a result of obtaining bit logical sums for each of the terminal identification IDs, between the tables.

6. The base station apparatus according to claim 2, wherein
the processor repeatedly for the cells so as to obtain the usable terminal identification ID usable across the cells subject to the carrier aggregation, acquires the table of the terminal identification IDs from each of the cells subject to the carrier aggregation and obtains bit logical sums for each of the terminal identification IDs, between the tables for a pair of cells among the cells.

7. The base station apparatus according to claim 1, wherein
the processor obtains the usable terminal identification ID usable across the cells subject to the carrier aggregation through a handover process procedure performed internally by the base station apparatus.
